(19) United States
(12) Patent Application Publication
(10) Pub. No.: US 2025/0392592 A1
(43) Pub. Date: Dec. 25, 2025

(54) NETWORK ACCESS METHOD AND APPARATUS

(71) Applicant: GUANGDONG OPPO MOBILE TELECOMMUNICATIONS CORP., LTD., Dongguan (CN)

(72) Inventors: Zhao RU, Dongguan (CN); Chaoming LUO, Dongguan (CN)

(21) Appl. No.: 19/309,824

(22) Filed: Aug. 26, 2025

Related U.S. Application Data
(63) Continuation of application No. PCT/CN2023/089891, filed on Apr. 21, 2023.

(51) Int. Cl. H04L 9/40

(52) U.S. Cl. CPC H04L 63/0869; H04L 63/0823

(57) ABSTRACT

Provided are methods for accessing a network, a first device and a second device, a third device and fourth device. A method for accessing a network includes: a first device performs bidirectional authentication corresponding to a target authentication mode with a fourth device, so as to access a communication network supporting the target authentication mode.

### CROSS-REFERENCE TO RELATED APPLICATIONS

This application is a continuation of International Application No. PCT/CN2023/089891, filed on Apr. 21, 2023, the disclosure of which is hereby incorporated by reference in its entirety.

### TECHNICAL FIELD

This application relates to the field of communications technologies, and more specifically, to a method and apparatus for accessing a network.

### BACKGROUND

With continuous development of technologies, an increasing quantity of terminal devices support a networking function. Therefore, how to improve user experience of using networked devices has become an urgent technical problem to be solved.

### SUMMARY

This application provides a method and apparatus for accessing a network. The following describes various aspects involved in embodiments of this application.

According to a first aspect, there is provided a method for accessing a network. The method includes: performing, by a first device with a fourth device, mutual authentication corresponding to a target authentication mode, to access a communication network that supports the target authentication mode.

According to a second aspect, there is provided a method for accessing a network. The method includes: transmitting, by a second device, first information to a first device, where the first information is used to indicate that a communication network where the second device is located supports a target authentication mode.

According to a third aspect, there is provided a method for accessing a network. The method includes: transmitting, by a third device, third information to a first device, where the third information is used to trigger the first device to transmit second information, and the second information is used to find a communication network that supports the target authentication mode.

According to a fourth aspect, there is provided a method for accessing a network. The method includes: performing, by a fourth device with a first device, mutual authentication corresponding to a target authentication mode, to cause the first device to access a communication network that supports the target authentication mode.

According to a fifth aspect, there is provided an apparatus for accessing a network. The apparatus includes an authentication unit, configured to perform mutual authentication corresponding to a target authentication mode with a fourth device, to access a communication network that supports the target authentication mode.

According to a sixth aspect, there is provided an apparatus for accessing a network. The apparatus includes a transmitting unit, configured to transmit first information to a first device, where the first information is used to indicate that a communication network where the apparatus is located supports a target authentication mode.

According to a seventh aspect, there is provided an apparatus for accessing a network. The apparatus includes a transmitting unit, configured to transmit third information to a first device, where the third information is used to trigger the first device to transmit second information, and the second information is used to find a communication network that supports the target authentication mode.

According to an eighth aspect, there is provided an apparatus for accessing a network. The apparatus includes an authentication unit, configured to perform mutual authentication corresponding to a target authentication mode with a first device, to cause the first device to access a communication network that supports the target authentication mode.

According to a ninth aspect, there is provided an apparatus for accessing a network. The apparatus includes a memory and a processor, where the memory is configured to store a program, and the processor is configured to invoke the program in the memory to execute a method according to any one of the first aspect to the fourth aspect.

According to a tenth aspect, there is provided an apparatus for accessing a network. The apparatus includes a processor configured to invoke a program from a memory to execute a method according to any one of the first aspect to the fourth aspect.

According to an eleventh aspect, a chip is provided, and includes a processor configured to invoke a program from a memory to cause a device on which the chip is installed to execute a method according to any one of the first aspect to the fourth aspect.

According to a twelfth aspect, a computer-readable storage medium is provided, where a program is stored on the computer-readable storage medium, and the program causes a computer to execute a method according to any one of the first aspect to the fourth aspect.

According to a thirteenth aspect, a computer program product is provided, and includes a program, where the program causes a computer to execute a method according to any one of the first aspect to the fourth aspect.

According to a fourteenth aspect, a computer program is provided, where the computer program causes a computer to execute a method according to any one of the first aspect to the fourth aspect.

### BRIEF DESCRIPTION OF DRAWINGS

FIG. 1 is an example diagram of an application scenario according to an embodiment of this application.

FIG. 2 is a schematic flowchart of a method for accessing a network according to an embodiment of this application.

FIG. 3 is a schematic flowchart of a method for accessing a network according to another embodiment of this application.

FIG. 4 is a schematic flowchart of a method for accessing a network according to still another embodiment of this application.

FIG. 5 is a schematic flowchart of a method for accessing a network according to still another embodiment of this application.

FIG. 6 is a schematic structural diagram of an apparatus for accessing a network according to an embodiment of this application.

FIG. 7 is a schematic structural diagram of an apparatus for accessing a network according to another embodiment of this application.

FIG. 8 is a schematic structural diagram of an apparatus for accessing a network according to still another embodiment of this application.

FIG. 9 is a schematic structural diagram of an apparatus for accessing a network according to still another embodiment of this application.

FIG. 10 is a schematic structural diagram of an apparatus according to an embodiment of this application.

### DESCRIPTION OF EMBODIMENTS

Technical solutions in this application are described below with reference to the accompanying drawings.

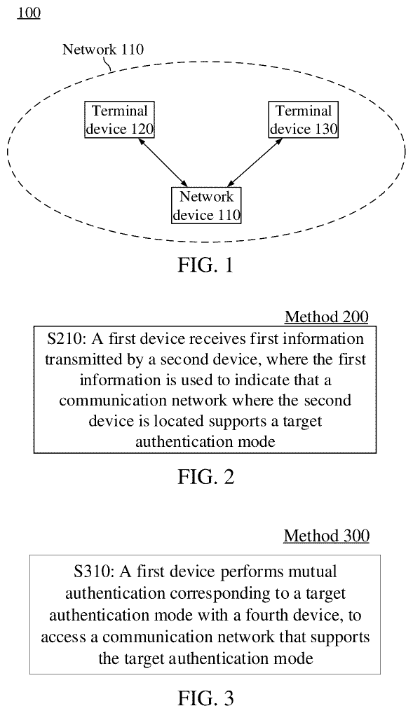

FIG. 1 is a diagram of an application scenario 100 according to an embodiment of this application. The application scenario 100 may include a network device 110, a terminal device 120, and a terminal device 130. The network device 110 may provide communication coverage for a specific geographic area, and may communicate with the terminal device 120 and the terminal device 130 within the coverage. The terminal device 120 and the terminal device 130 may access a network 110 by using the network device 110.

FIG. 1 exemplarily shows one network device and two terminal devices. Optionally, the application scenario 100 may include more or fewer network devices or terminal devices. This is not limited in embodiments of this application. It should be understood that embodiments of this application are not limited to the system architecture shown in FIG. 1. The technical solutions in embodiments of this application may be applied to various system architectures. This is not limited in embodiments of this application.

The network device 110 in embodiments of this application may also be referred to as an access point (AP) or the like. For example, the network device 110 may be a network controller, a router, a mobile phone, a tablet computer (Pad), a notebook computer, a palmtop computer, a wearable device, or the like.

The terminal device 120 and the terminal device 130 in embodiments of this application may also be referred to as a node device, a node, an access node, a wireless node, a transmission node, a transceiver node, user equipment (UE), or the like. For example, the terminal device 120 and the terminal device 130 may be devices such as lighting devices; door locks; shutters; televisions; heating, ventilation, and air conditioning systems; security sensors and controllers; gateways; or the like.

The terminal device 120 in embodiments of this application may be a device (that is, a management device) that has an administrator privilege in the network 110. For example, the terminal device 120 may configure the terminal device 130 to access the network 110. The terminal device 120 may also be referred to as a management device, user equipment, a commissioner, or the like. For example, the terminal device 120 may be a mobile phone, a tablet computer, a notebook computer, a palmtop computer, a wearable device, or the like.

The network 110 in FIG. 1 may be Wi-Fi, Ethernet, or Thread. Currently, network interfaces may be managed by using a network commissioning cluster. The network commissioning cluster is described below.

Network commissioning is part of entire node commissioning. A primary objective of the network commissioning cluster is to associate a node with one or more network interfaces of the node or to manage them. These network interfaces may include the following types: Wi-Fi (such as IEEE802.11), Ethernet (such as 802.3), and Thread (such as 802.15.4).

The network commissioning cluster includes a plurality of commands and attributes, which are described in detail below.

### (1) ScanNetworks Command

This command may scan, on a network interface associated with a cluster instance, for either of the following: all available networks (non-directed scanning); and a specific network (directed scanning).

Scanning for available networks detects all types of networks corresponding to the network interface associated with the cluster server instance. These networks may join, for example, all visible Wi-Fi access points for Wi-Fi cluster server instances, or all Thread personal area networks (PAN) for Thread cluster server instances, within a range of a maximum response size.

Scanning for a specific network (that is, directed scanning) is performed if a network identifier (for example, a Wi-Fi service set identifier (SSID)) is provided in a command parameter. Directed scanning shall restrict a result set to the specified network only.

A client shall not expect the server to complete the scan and respond with a ScanNetworksResponse command before ScanMaxTimeSeconds seconds have elapsed. Enough transmission time for retries shall be expected before the client determines that the operation has timed out.

This command fails and a status code is BUSY if the server determines that the server fails to reliably transmit a response due to changes of network interface configuration at runtime for the interface over which this command was invoked, or if it is currently unable to proceed with such an operation.

Clients shall be resilient to a server that does not support or cannot proceed with the “ScanNetworks” command.

Parameters for this command are as follows:

| | | | | Qual- | Default | Confor- |
|---|---|---|---|---|---|---|
| ID | Name | Type | Constraint | ity | value | mance |
| 0 | SSID | [octstr-def] | 1 to 32 | X | null | [WI] |
| 1 | Breadcrumb | uint64 | all | | | O |

SSID field: This field, if present, shall contain a SID for directed scanning of a particular Wi-Fi SSID. Otherwise, if this field is absent, or it is null, this shall indicate scanning of all BSSIDs within a range. This field shall be ignored for ScanNetworks invocations on non-Wi-Fi server instances.

Breadcrumb field: The Breadcrumb field, if present, shall be used to automatically set a Breadcrumb attribute in a general commissioning cluster upon success of the associated command. If the command fails, the Breadcrumb attribute in the general commissioning cluster shall be left unchanged.

### (2) ScanNetworksResponse Command

This command shall contain a status of the last ScanNetworks command, and associated scan results if the operation is successful.

| | | | | | |
|---|---|---|---|---|---|
| ID | Name | Type | Constraint | Default | Conformance |

| | | | | |
|---|---|---|---|---|
| 0 | NetworkingStatus | NetworkCommissioningStatus | desc | M |
| 1 | DebugText | [string-def] | max 512 | O |
| 2 | WiFiScanResults | [list-def][WiFiInterfaceScanResult] | desc | WI |
| 3 | ThreadScanResults | [list-def][ThreadInterfaceScanResult] | desc | TH |

Results are valid only if NetworkingStatus is Success.

Before generating a ScanNetworksResponse, the server shall set the LastNetworkingStatus attribute value to NetworkingStatus matching the response.

### \textcircled{1} NetworkingStatus Field

The NetworkingStatus field shall indicate a status of a last scan operation, and has one of the following values:
Success: Scanning succeeded.
NetworkNotFound: No instance of an explicitly provided network identifier was found during the scan. This error does not occur if no network identifier is provided, such as during the scan for all available networks.
OutOfRange: A network identifier is invalid (for example, empty, too long, or the like).
RegulatoryError: Could not scan on any bands due to lack of regulatory configuration.
UnknownError: An internal error occurs during the scan.

### \textcircled{2} DebugText Field

This field, if present and non-empty, may contain error information which may be communicated to a user in a case in which NetworkingStatus is not Success. Its purpose is to help developers in troubleshooting errors and may go into logs or crash reports.

### \textcircled{3} WiFiScanResults (Wi-Fi Scan Results)

If NetworkingStatus is Success, this field shall contain a Wi-Fi network scan result. The list may be empty if none were found within a range of bands supported by the interface, or if directed scanning has been used and no desired SSID has been found within a range.

A maximum quantity of results in a result list supported may depend on memory and may contain a subset of possibilities, to avoid memory exhaustion on the cluster server and avoid exceeding a maximum command response size supported.

Order in which results are reported depends on specific implementation. Results should be reported in decending order of RSSIs, even if no received signal strength indicator (RSSI) is reported in the response, to maximize a probability that most likely to be reachable elements are included within size limits of the response.

a. WiFiInterfaceScanResult Structure

The WiFiInterfaceScanResult structure represents a single Wi-Fi network scan result.

| | | | | | | |
|---|---|---|---|---|---|---|
| | | | | | | Confor- |
| ID | Name | Type | Constraint | Quality | Access | mance |

| | | | | |
|---|---|---|---|---|
| 0 | Security | WiFiSecurity | all | WI |
| 1 | SSID | [octstr-def] | max 32 | WI |
| 2 | BSSID | [octstr-def] | 6 | WI |
| 3 | Channel | uint16 | all | WI |
| 4 | WiFiBand | WiFiBand | all | [WI] |
| 5 | RSSI | int8 | all | [WI] |

The WiFiBand field, if present, may be used to distinguish between overlapping channel number values of different Wi-Fi frequency bands.

RSSI, if present, shall denote a signal strength in dBm of an associated scan result.

b. WiFiSecurity Bitmap

The WiFiSecurity type is derived from a map8 data type.

The WiFiSecurity bitmap encodes a supported Wi-Fi security type in a Security field of a Wi-Fi interface scan result.

| Bit | Description |
|---|---|
| 0 | Unencrypted |
| 1 | WEP |
| 2 | WPA-PERSONAL |
| 3 | WPA2-PERSONAL |
| 4 | WPA3-PERSONAL |

c. WiFiBand Enum

The WiFiBand type is derived from an enum8 data type.

The WiFiBand Enum encodes a supported Wi-Fi frequency band in the WiFiBand field of a Wi-Fi interface scan result.

| Value | Description |
|---|---|
| 0 | 2.4 GHz-2.401 GHz to 2.495 GHz (802.11b/g/n/ax) |
| 1 | 3.65 GHz-3.655 GHz to 3.695 GHz (802.11y) |
| 2 | 5 GHz-5.150 GHz to 5.895 GHz (802.11a/n/ac/ax) |
| 3 | 6 GHz-5.925 GHz to 7.125 GHz (802.11ax/WiFi 6E) |
| 4 | 60 GHz-57.24 GHz to 70.20 GHz (802.11ad/ay) |

### \textcircled{4} ThreadScanResults (Thread Scan Result)

If NetworkingStatus is Success, this field shall contain a Thread network scan result. The list may be empty if none were found within a range of bands supported by the interface.

A maximum quantity of results in a result list supported may depend on memory and may contain a subset of possibilities, to avoid memory exhaustion on the cluster server and avoid exceeding a maximum command response size supported.

Order in which results are reported depends on specific implementation. Results should be reported in descending order of link quality indicators (LQI), to maximize a probability that most likely to be reachable elements are included within size limits of the response.

### (3) AddOrUpdateWiFiNetwork Command

This command shall be used to add or modify Wi-Fi network configurations.

If this command is received without an environment with fail-safe, then this command fails and a FAILSAFE_REQUIRED status code is transmitted back to the initiator.

The Credentials associated with the network are not readable after execution of this command, as they do not appear in the Networks attribute list, for security reasons.

Reference may be made to “Common processing of AddOrUpdateWiFiNetwork and AddOrUpdateThreadNetwork” for behavior of addition/update.

Data for this command is as follows:

| | | | | | |
|---|---|---|---|---|---|
| ID | Name | Type | Constraint | Default | Conformance |

| | | | | |
|---|---|---|---|---|
| 0 | SSID | [octstr-def] | max 32 | M |
| 1 | Credentials | [octstr-def] | max 64 | M |
| 2 | Breadcrumb | uint64 | all | O |

### \textcircled{1} SSID Field

This field shall contain an SSID attempted to be connected to. Specific BSSID selection is not supported by this cluster.

### 2 Credentials Field

Credentials is the passphrase or PSK for the network (if needed).

Security type, cipher, and credential format (passphrase or pre-shared key (PSK)) shall be contextually automatically selected during execution of the ConnectNetwork command and during subsequent operational state network connections, based on the most secure Wi-Fi security type available within beacons and probe responses for the set of all discovered basic service set identifiers (BSSIDs) for the configured SSID. The type of PSK or passphrase used shall be inferred based on a length and content of the “Credentials” field provided, matching the selected security type.

Valid Credentials lengths are:
0 bytes: Unsecured (open) connection
5 bytes: wired equivalent privacy (WEP)-64 passphrase
10 hexadecimal ASCII characters: WEP-64 40-bit hexadecimal raw PSK
13 bytes: WEP-128 passphrase
26 hexadecimal ASCII characters: WEP-128 104-bit hexadecimal raw PSK
8 . . . 63 bytes: Wi-Fi protected access (WPA)/WPA2/WPA3 passphrase
64 bytes: WPA/WPA2/WPA3 raw hexadecimal PSK

These lengths shall be contextually interpreted based on the security type of the basic service set identifier (BSSID) where connection will occur.

When the length of Credentials and available set of BSSID allow a plurality of options, such as presence of both WPA2 and WPA security types in the result set, WPA2 shall be considered more secure.

It should be noted that, if link quality is deemed to be too low to achieve successful operation, or if all retry attempts fail, the following case may occur: a station cannot be connected to a particular access point with higher security and selects a lower security connectivity type.

### \textcircled{3} Breadcrumb Field

Reference is made to the foregoing description of the Breadcrumb field. Details are not described herein again.

### (4) NetworkConfigResponse Command

This response command is associated with status information of some commands which require it as their response command. Reference is made to each individual cluster server command for a situation that may cause a NetworkingStatus different than Success.

Data for this command is as follows:

| | | | | | |
|---|---|---|---|---|---|
| ID | Name | Type | Constraint | Default | Conformance |

| | | | | |
|---|---|---|---|---|
| 0 | NetworkingStatus | NetworkCommissioningStatus | desc | M |
| 1 | DebugText | [string-def] | max 512 | O |
| 2 | NetworkIndex | uint8 | 0 to | O |
| | | | (MaxNetworks − 1) | |

Before generating a NetworkConfigResponse, the server shall set a LastNetworkingStatus attribute value to the NetworkingStatus matching the response.

Before generating a NetworkConfigResponse, the server shall set the LastNetworkID attribute value to the NetworkID that was used in the command for which an invocation caused the response to be generated.

### \textcircled{1} NetworkingStatus Field

The NetworkingStatus field shall indicate a status of a last operation attempting to modify the Networks attribute configuration, and has one of the following values:
Successs: Operation succeeded.
OutOfRange: Network identifier was invalid (e.g. empty, too long, or the like).
BoundsExceeded: Adding this network configuration would exceed the limit defined by the MaxNetworks attribute.
NetworkIdNotFound: The network identifier was expected to be found, but was not found among the added network configurations in Networks attribute.
UnknownError: An internal error occurred during the operation.

### \textcircled{2} DebugText Field

Reference is made to the foregoing description of the DebugText field. Details are not described herein again.

### \textcircled{3} NetworkIndex

When NetworkingStatus is Success, this field shall be present. This field shall contain a 0-based index of an entry in the Networks attribute that was last added, updated, or removed successfully by an associated request command.

### (5) ConnectNetwork Command

This command is used to attempt to connect to a network whose configuration was previously added by either the AddOrUpdateWiFiNetwork or AddOrUpdateThreadNetwork command. Network is identified by its NetworkID.

Data for this command is as follows:

| ID | Name | Type | Constraint | Conformance |
|---|---|---|---|---|
| 0 | NetworkID | [octstr-def] | 1 to 32 | M |
| 1 | Breadcrumb | uint64 | all | O |

This command fails and a BUSY status code is returned to the initiator if the server is currently unable to proceed with such an operation, such as if the server is currently attempting to connect in the background, or is already proceeding with a previous ConnectNetwork.

If this command is received without an environment with fail-safe, then this command fails and a FAILSAFE_REQUIRED status code is transmitted back to the initiator.

Success or failure of this command shall be communicated by using the ConnectNetworkResponse command, unless some data model validations caused a FAILURE state to be transmitted before finishing execution of the command. The ConnectNetworkResponse shall indicate the value Success in the NetworkingStatus field upon a successful connection. Upon a failure to connect, the ConnectNetworkResponse shall contain an appropriate NetworkingStatus, DebugText, and ErrorValue to indicate a reason for the failure.

An amount of time required to determine successful or failed connectivity on the interface associated with the cluster server is provided by the ConnectMax TimeSeconds attribute. Clients shall not consider the connection to have timed out until at least that duration elapses. For non-concurrent commissioning situations, the client should allow additional margin of time to account for its delay in executing operational discovery of a node once the node is connected to a new network.

Upon a successful connection, an entry associated with a given network configuration in the Networks attribute shall indicate that its Connected field is set to true, and all other entries (if any exist) shall indicate that their Connected fields are set to false.

Upon a connection failure, the entry associated with the given network configuration in the Networks attribute shall indicate that its Connected field is set to false.

The precedence order of any entry subject to ConnectNetwork shall not change within the Networks attribute.

Even after a successful connection to a network, the configuration shall be reverted to a previous configuration state if the CommissioningComplete command is not successfully invoked before expiry of a Fail-Safe timer.

When non-concurrent commissioning is being used by a commissioner or an administrator, the only method to determine whether the operation is successful may be to discover a node on a new operational network. Therefore, before invoking the ConnectNetwork command, the client should re-invoke the Arm Fail-Safe command with a duration that meets the following:
Sufficient time to meet a minimum required time that may be used by the server to be connected to a desired network.
Sufficient time to account for possible message-layer retries when a response is requested.
Sufficient time to allow operational discovery on the new network by a commissioning node or administrator.
Sufficient time to establish a CASE session after operational discovery.
Not so long that, in error situations, the delay to reverting back to being discoverable for commissioning with a previous configuration would cause significant user-perceived delay.

It should be also noted that the CommissioningTimeout duration provided in a previous OpenCommissioningWindow or OpenBasicCommissioningWindow command may impact the total time available to proceed with error recovery after a connection failure.

The LastNetworkingStatus, LastNetworkID, and LastConnectErrorValue attributes may assist the client in determining a reason for a failure after reconnecting over a commissioning channel, especially in non-concurrent commissioning situations.

### \textcircled{1} NetworkID Field

This field shall contain a NetworkID for an entry used to configure the connection: the SSID for Wi-Fi and the extended personal area network (XPAN) identifier (ID) for Thread.

### \textcircled{2} Breadcrumb Field

Reference is made to the foregoing description of the Breadcrumb field. Details are not described herein again.

### \textcircled{6}ConnectNetworkResponse Command

Data for this command is as follows:

| ID | Name | Type | Constraint | Quality | Conformance |
|---|---|---|---|---|---|
| 0 | NetworkingStatus | NetworkCommissioningStatus | all | | M |
| 1 | DebugText | [string-def] | | | O |
| 2 | ErrorValue | int32 | all | X | M |

Before generating a ConnectNetworkResponse, the server shall:
Set the LastNetworkingStatus attribute value to the NetworkingStatus matching the response.
Set the LastNetworkID attribute value to the NetworkID that was used in the ConnectNetwork command which caused the response to be generated.
Set the LastConnectErrorValue attribute value to the Error Value matching the response, including setting it to null if the Error Value is not applicable.

### \textcircled{1} NetworkingStatus Field

The NetworkingStatus field shall indicate a status of a last connection attempt, and has one of the following values:
Success: Connection succeeded.
NetworkNotFound: No instance of an explicitly-provided network identifier was found during the attempt to join the network.
OutOfRange: Network identifier was invalid (e.g. empty, too long, or the like).
NetworkIdNotFound: The network identifier was not found among the added network configurations in Networks attribute.
RegulatoryError: Could not be connected to a network due to lack of regulatory configuration.
UnknownError: An internal error occurred during the operation.
Association errors (see also description of errors in NetworkCommissioningStatus enum): AuthFailure, UnsupportedSecurity, OtherConnectionFailure, IPV6Failed, and IPBindFailed

### \textcircled{2} DebugText Field

Reference is made to the foregoing description of the DebugText field. Details are not described herein again.

### \textcircled{3} ErrorValue Field

ErrorValue interpretation for Wi-Fi association errors:

Upon any association failure during enabling of a network, the Error Value field shall be set to a status code value that was present in a last frame related to association where status code was not equal to zero and which caused the failure of a final retry attempt, if this final failure was due to one of the following management frames:
Association Response (Type 0, Subtype 1);
Reassociation Response (Type 0, Subtype 3); or
Authentication (Type 0, Subtype 11)

Table 9-50 “Status Codes” in IEEE802.11 contains a description of all possible values, which can unambiguously be used to determine the cause, such as an invalid security type, unsupported rate, etc.
Otherwise, the ErrorValue field shall contain an implementation-dependent value which may be used by a reader of the structure to record, report or diagnose the failure.

### (7) ReorderNetwork Command

This command shall set specific order of a network configuration selected by its NetworkID in the Networks attribute list to match a position given by NetworkIndex.

Data for this command is as follows:

| ID | Name | Type | Constraint | Conformance |
|---|---|---|---|---|
| 0 | NetworkID | [octstr-def] | 1 to 32 | M |
| 1 | NetworkIndex | uint8 | desc | M |
| 2 | Breadcrumb | uint64 | all | O |

### \textcircled{1} NetworkID Field

This field shall contain a NetworkID for an entry to reorder: the SSID for Wi-Fi and XPAN ID for Thread.

### \textcircled{2} NetworkIndex Field

This field shall contain a 0-based index of a new desired position of an entry in the Networks attribute.

### \textcircled{3} Breadcrumb Field

Reference is made to the foregoing description of the Breadcrumb field. Details are not described herein again.

The following effects may be generated when the command is received.

If the Networks attribute does not contain a matching entry, the command shall immediately respond with NetworkConfigResponse having NetworkingStatus status field set to NetworkIdNotFound.

If the NetworkIndex field has a value greater than or equal to a current quantity of entries in the Networks attribute, the command shall immediately respond with NetworkConfigResponse having NetworkingStatus status field set to OutOfRange.

Upon success, the NetworkConfigResponse command shall have its NetworkIndex field set to the 0-based index of the entry in the Networks attribute that was just updated, matching the incoming NetworkIndex, and a NetworkingStatus status field is set to Success.

The entry selected shall be inserted at the new position in the list. All other entries, if present, shall be moved to allow the insertion, in a way that they all retain their existing relative order between each other, with the exception of the newly re-ordered entry.

Re-ordering to the same NetworkIndex as the current position shall be considered as a success and yield no visible changes of the Networks attribute.

### (8) Attributes

| ID | Name | Type | Constraint | Quality | Default | Access | Conformance |
|---|---|---|---|---|---|---|---|
| 0x0000 | MaxNetworks | uint8 | min 1 | F | | R A | M |
| 0x0001 | Networks | [list-def][NetworkInfo] | maxMaxNetworks | | empty | R A | M |
| 0x0002 | ScanMaxTimeSeconds | uint8 | desc | F | | R V | WI \| TH |
| 0x0003 | ConnectMaxTimeSeconds | uint8 | desc | F | | R V | WI \| TH |
| 0x0004 | InterfaceEnabled | bool | | N | true | RW VA | M |
| 0x0005 | LastNetworkingStatus | NetworkCommissioningStatus | | X | null | R A | M |
| 0x0006 | LastNetworkID | [octstr-def] | 1 to 32 | X | null | R A | M |
| 0x0007 | LastConnectErrorValue | int32 | | X | null | R A | M |

### \textcircled{1} MaxNetworks Attribute

This shall indicate a maximum quantity of network configuration entries that can be added, based on available device resources.
A length of the Networks attribute list shall be less than or equal to this value.

### \textcircled{2} Networks Attribute

This attribute shall indicate network configurations that are usable on the network interface represented by this cluster server instance.

The order of configurations in the list reflects precedence. That is, at any time a node attempts to access the network, the node shall attempt to do so using the configurations in Networks Attribute in the order as they appear in the list.

The order of list items shall only be modified by the AddOrUpdateThreadNetwork, AddOrUpdateWiFiNetwork, and ReorderNetwork commands. In other words, the list shall be stable over time, unless great change occurs exterally.

Ethernet networks shall be automatically populated by the cluster server. Ethernet network commissioning cluster instances shall always have exactly one NetworkInfo structure instance in their Networks attribute. There shall be no way to add Ethernet network configurations to, update Ethernet network configurations in, or delete Ethernet network configurations from those Cluster instances.

a. NetworkInfo Structure

The NetworkInfo structure describes an existing network configuration, as provided in the Networks attribute.

| | | | | | | |
|---|---|---|---|---|---|---|
| | | | | Qual- | | Confor- |
| ID | Name | Type | Constraint | ity | Access | mance |

| | | | | |
|---|---|---|---|---|
| 0 | NetworkID | [octstr-def] | 1 to 32 | M |
| 1 | Connected | bool | | M |

i. NetworkID Field

Every network is uniquely identified (for purposes of commissioning) by a NetworkID mapping to the following technology-specific properties:
Wi-Fi: SSID
Extended PAN ID for Thread
Network interface instance name at operating system (or equivalent unique name) for

### Ethernet

Therefore, the semantics of the NetworkID field varies between network types accordingly. It contains an SSID for Wi-Fi networks, Extended PAN ID (XPAN ID) for Thread networks, and netif name for Ethernet networks.

XPAN ID is a big-endian 64-bit unsigned number, represented on the first 8 octets of the octet string.

ii. Connected Field

This field shall indicate a connection status of an associated network, where “connected” means being currently connected to a network technology (for example, being associated with a Wi-Fi network, media being connected to an Ethernet network).

### \textcircled{3} ScanMax TimeSeconds Attribute

This attribute shall indicate a maximum duration (in seconds) taken by the network interface on this cluster server instance to provide scan results.

For usage, reference is made to the ScanNetworks command.

### \textcircled{4} ConnectMax TimeSeconds Attribute

This attribute shall indicate a maximum duration (in seconds) taken by the network interface on this cluster server instance to report a successful or failed network connection indication. All required operations shall be considered in the maximum duration until a successful network connection is deemed to have occurred, including, for example, obtaining IP addresses, or the execution of necessary internal retries.

### \textcircled{5} InterfaceEnabled Attribute

This attribute shall indicate whether the associated network interface is enabled or not. By default, all network interfaces should be enabled during initial commissioning (InterfaceEnabled is set to true).

It is undefined what happens if InterfaceEnabled is written to false on the same interface as that which is used to write the value. In this case, the administrator may have to await expiry of the fail-safe, and restore network configuration to previous safe values, before being able to communicate with the node again.

It may be possible to disable Ethernet interfaces but it is implemented by definition. If not supported, writing to this attribute with a value of false leads to a failure with a status of INVALID_ACTION. When disabled, an Ethernet interface would longer employ media detection. That is, a simple unplug and replug of the cable shall not re-enable the interface.

On Ethernet-only Nodes, there shall always be at least one network commissioning server cluster instance with InterfaceEnabled set to true.

### \textcircled{6} LastNetworkingStatus Attribute

This attribute shall indicate a status of a last attempt to either scan or access an operational network by using this interface, no matter whether by invocation of the ConnectNetwork command or by autonomous connection after loss of connectivity or during initial establishment. If no such attempt was made, or no network configurations exist in the Networks attribute, then this attribute shall be set to null.

This attribute is present to assist with error recovery during network commissioning and to assist in non-concurrent networking commissioning flows.

### \textcircled{7} LastNetworkID Attribute

This attribute shall indicate a NetworkID used in a last attempt to access an operational network by using this interface, no matter whether by invocation of the ConnectNetwork command or by autonomous connection after loss of connectivity or during initial establishment. If no such attempt was made, or no network configurations exist in the Networks attribute, then this attribute shall be set to null.

If a network configuration is deleted from the Networks attribute using the RemoveNetwork command after a connection attempt, this field may indicate a NetworkID that is no longer configured on the node.

This attribute is present to assist with error recovery during network commissioning and to assist in non-concurrent networking commissioning flows.

### \textcircled{8} LastConnectErrorValue Attribute

This attribute shall indicate an ErrorValue used in a last failed attempt to access an operational networkby using this interface, no matter whether by invocation of the ConnectNetwork command or by autonomous connection after loss of connectivity or during initial establishment. If no such attempt was made, or no network configurations exist in the Networks attribute, then this attribute shall be set to null.

If the last connection succeeded, as indicated by a value of Success in the LastNetworkingStatus attribute, then this field shall be set to null. This attribute is present to assist with error recovery during network commissioning and to assist in non-concurrent networking commissioning flows.

Due to network parameter changes or another reason, a terminal device may be disconnected (disconnected from a network). In this case, the terminal device may attempt to reaccess the network. However, due to network parameter changes or another reason, the terminal device may fail to reaccess the network. Therefore, how to increase a success rate of accessing a network by a terminal device has become an urgent technical problem required to be resolved.

To resolve one or more of the foregoing technical problems, this application provides a method and apparatus for accessing a network. With reference to FIG. 2 to FIG. 5, the following describes embodiments of this application in detail by using examples.

FIG. 2 is a schematic flowchart of a method for accessing a network according to an embodiment of this application. The method 200 shown in FIG. 2 may include step S210. Details are as follows.

In S210, a second device transmits first information to a first device.

The first device may be an internet of things (IoT) device, for example, the terminal device shown in FIG. 1. The second device may be a network device, for example, the network device shown in FIG. 1.

The first information may be used to indicate that a communication network where the second device is located supports a target authentication mode. Optionally, the supporting a target authentication mode may refer to supporting accessing the communication network by using the target authentication mode.

The communication network may be a wired network or a wireless network. For example, the communication network may be Wi-Fi, Ethernet, or Thread. The second device may be simultaneously located in one or more communication networks. Some or all of the one or more communication networks may support the target authentication mode.

Optionally, the first information may include an identifier of supporting the target authentication mode (for example, the identifier may be used to indicate that one or more communication networks support access using the target authentication mode), an identifier of a communication network (for example, an identifier of a communication network supporting the target authentication mode), and/or an identifier of a Fabric network where the second device is located. The identifier, included in the first information, of the Fabric network where the second device is located may be a Fabric network list, and the Fabric network list may include identifiers of one or more Fabric networks.

The Fabric network may refer to an ecological platform (which may also be referred to as an ecological network). Different ecological platforms may correspond to different ecological manufacturers. For example, an ecological network A may correspond to an ecosystem A of Google, and an ecological network B may correspond to an ecosystem B of Xiaomi.

Optionally, the first information may be carried in a Probe Response frame. For example, the first information may be an information element (IE) in the Probe Response frame.

The target authentication mode may refer to authentication performed by using a node operational certificate (NOC) in a Fabric network. For example, the target authentication mode may refer to Matter (Matter protocol) authentication, that is, authentication performed using a Matter NOC in the Fabric as a credential.

In embodiments of this application, the first information is used to indicate that the communication network where the second device is located supports the target authentication mode, and the first device receives the first information transmitted by the second device, which helps the first device access, based on the first information, the communication network that supports the target authentication mode, thereby facilitating increasing a success rate of accessing a network by the device.

In some embodiments, before S210, the first device may transmit second information to the second device. Optionally, the first device may broadcast the second information to a plurality of devices including the second device.

Optionally, the second information may be used to discover a communication network that supports the target authentication mode. Optionally, the second information may include first indication information used to indicate the target authentication mode. Optionally, the first indication information may indicate an identifier of the target authentication mode. For example, the first indication information may be a MatterType field. The MatterType field may be of a Boolean type. For example, if the MatterType field is True, it indicates scaning for a communication network that supports the target authentication mode; otherwise, it indicates not scanning for a communication network that supports the target authentication mode.

Optionally, the second information may be carried in a Probe Request frame. For example, the second information may be an information element (IE) in the Probe Request frame.

In some embodiments, before the first device transmits the second information to the second device, a third device may transmit third information to the first device. Optionally, the third information may be used to trigger the first device to transmit the second information, in other words, may be used to instruct the first device to perform a scan for a communication network that supports the target authentication mode.

Optionally, the third information may include a MatterType field. Optionally, the third information may be carried in a ScanNetworks command. For example, the MatterType field may be added to the ScanNetworks command, so as to instruct the first device whether to perform a scan for a communication network that supports the target authentication mode.

In some embodiments, after S210, the first device may transmit fourth information to the third device. Optionally, the fourth information may be used to indicate a communication network that supports the target authentication mode.

The third device may be a management device (in a communication network and/or a Fabric network), for example, the terminal device 120 in FIG. 1. For example, the third device may be a commissioner. For example, an application (APP) in a mobile phone or another terminal device of a user may serve as a commissioner in a communication network (or a Fabric network).

Optionally, the fourth information may include an identifier of at least one communication network and/or an identifier of a Fabric network where the second device is located. Optionally, the at least one communication network may be a communication network that is indicated by the second device by using the first information and that supports the target authentication mode. Optionally, the first device may determine an intersection set between Fabric networks where the first device is located and Fabric networks where the second device is located. Optionally, the fourth information may include an identifier of a Fabric network in the intersection set.

Optionally, the fourth information may be carried in a ScanNetworksResponse command. For example, the fourth information may be a parameter in the ScanNetworksResponse command.

In some embodiments, after S210, the third device transmits fifth information to the first device. Optionally, the fifth information may be used to indicate a first communication network that supports the target authentication mode.

Optionally, the fifth information may include an identifier of the first communication network and an identifier of a first Fabric network.

Optionally, the fifth information may be carried in an AddOrUpdate WiFiNetwork command. For example, the fifth information may be a parameter in the AddOrUpdate WiFiNetwork command, such as a FabricID parameter.

Optionally, the third device may determine an intersection set between Fabric networks where the first device is located and Fabric networks where the second device is located. The third device may indicate the Fabric network in the intersection set to the first device by using the fifth information or other information.

Optionally, the fifth information may include an identifier of the first communication network and an identifier of a first Fabric network. The first Fabric network may be determined, by the third device, from the intersection set between the Fabric network where the first device is located and the Fabric network where the second device is located.

Further, the first device may add the first Fabric network to the Networks attribute. For example, the identifier of the first Fabric network may be stored in a FabricID field in the Networks attribute.

Optionally, the fifth information may include an identifier of the first communication network and/or second indication information. Optionally, the second indication information may be used to indicate that the first communication network supports use of the target authentication mode.

Further, the first device may add the Fabric network list to the Networks attribute. For example, the Fabric network list may be stored in a MatterFabrics field of the Networks attribute. The Fabric network list may be transmitted by using the first information in S210.

Optionally, the Fabric network list may include a Fabric network where a fourth device is located, or an intersection set between Fabric networks where the first device is located and Fabric networks where the fourth device is located. Optionally, the fourth device may be one of a plurality of devices that receive the second information broadcast by the first device. For example, the fourth device may be the second device.

Optionally, the third device may transmit sixth information to the first device. Optionally, the sixth information is used to indicate the first Fabric network. Optionally, the sixth information may instruct the first device to perform, by using the first Fabric network, authentication corresponding to the target authentication mode, so as to access the communication network.

Optionally, the sixth information may include an identifier of the first Fabric network. Optionally, the sixth information may be carried in a ConnectNetwork command. For example, the sixth information may be a parameter in the ConnectNetwork command.

In some embodiments, the third device may transmit seventh information to the first device. Optionally, the seventh information may be used to instruct the first device to adjust a priority of the first communication network. Optionally, the seventh information may be carried in a ReorderNetwork command.

Further, the first device may adjust a priority of the first communication network based on the seventh information. For example, the seventh information may instruct the first device to set the priority of the first communication network to the highest. In this way, when a connection is restored after a disconnection, the first device preferentially attempts to access the first communication network.

The foregoing describes a process in which the first device determines the first Fabric network and the first communication network. In this case, the first device may perform authentication by using the target authentication mode, to access the first communication network. Further, when the first device performs reconnecting to the network after a disconnection, if authentication is performed by using an authentication method in the first communication network (for example, an authentication method in Wi-Fi), a connection failure may be caused due to network parameter changes or another reason. Generally, a certificate of the device in the Fabric network does not change. If authentication is performed by using the target authentication mode, the device can conveniently reaccess the communication network, and a success rate of accessing the communication network by the device can be increased. The target authentication mode in this application may be used not only for initially accessing the communication network, but also for reaccess the communication network after the device is disconnected. With reference to FIG. 3, the following describes in detail a method for performing authentication by using the target authentication mode according to an embodiment of this application.

FIG. 3 is a schematic flowchart of a method for accessing a network according to an embodiment of this application. The method 300 shown in FIG. 3 may include step S310. Details are as follows.

In S310, a first device performs mutual authentication corresponding to the target authentication mode with a fourth device, to access a communication network that supports the target authentication mode.

Optionally, there is an intersection set between Fabric networks where the first device is located and Fabric networks where the fourth device is located. The first device and the fourth device may be authenticated by using a Fabric network in the intersection set.

In embodiments of this application, the first device performs mutual authentication corresponding to the target authentication mode, which helps the first device access the communication network that supports the target authentication mode, thereby facilitating increasing a success rate of accessing a network by the device.

In some embodiments, the mutual authentication corresponding to the target authentication mode may include the following steps.

The first device receives a second certificate transmitted by the fourth device, where the second certificate may be used for authentication by the first device, and the second certificate may be an NOC of the fourth device in the first Fabric network.

The first device transmits a first certificate to the fourth device, where the first certificate may be used for authentication by the fourth device, and the first certificate may be an NOC of the first device in the first Fabric network.

Optionally, the second certificate may be carried in a Sigma2 message. Optionally, the first certificate may be carried in a Sigma3 message. The Sigma2 message and the Sigma3 message may be messages during authentication in the Matter protocol.

In some embodiments, before the first device and the fourth device perform mutual authentication with each other, the first device may transmit eighth information to the fourth device. Optionally, the eighth information may be used to indicate the identifier of the first Fabric network and/or an identifier of the fourth device in the first Fabric network.

Optionally, the eighth information may be carried in a Sigma1 message. The Sigma1 message may be a message during authentication in the Matter protocol.

In some embodiments, the first device may interact with the fourth device by using a management frame in a communication network, so as to complete mutual authentication corresponding to the target authentication mode. For example, at least one of the Sigma1 message, the Sigma2 message, or the Sigma3 message is transmitted by using a Public Action frame.

Optionally, after the first device and the fourth device perform mutual authentication with each other, the first device may generate a first key based on the first certificate and the second certificate. For example, the first device may generate the first key based on the first certificate and the second certificate. Optionally, the first key may be a pre-shared key (PSK). Optionally, the fourth device may also generate a second key based on the first certificate and the second certificate. Optionally, the second key may be a PSK.

Optionally, the first device may access the first communication network based on the first key. For example, the first device may use the first key as a Wi-Fi password, to perform Wi-Fi authentication, and access the Wi-Fi network after the Wi-Fi authentication succeeds.

In some embodiments, the first device and the fourth device may first establish a network connection with each other, and then interact with each other via the network connection, so as to complete mutual authentication corresponding to the target authentication mode. Optionally, the network connection established between the first device and the fourth device may be unencrypted. For example, before the first device and the fourth device perform mutual authentication with each other, the first device and the fourth device may establish a first communication network connection with each other. The first communication network connection may be a connection corresponding to the first communication network.

Optionally, when establishing the first communication network connection, the first device may transmit ninth information to the fourth device. Optionally, the ninth information may be used to indicate the identifier of the first Fabric network. Optionally, the ninth information may be carried in a Wi-Fi Association Request frame.

Optionally, the fourth device may transmit tenth information to the first device. Optionally, the tenth information may be used to indicate an identifier of the fourth device in the first Fabric network. Optionally, the tenth information may be carried in a Wi-Fi Association Response frame.

Optionally, at least one of the Sigma1 message, the Sigma2 message, or the Sigma3 message may be transmitted via the first communication network connection.

In some embodiments, the mutual authentication corresponding to the target authentication mode may alternatively include the following steps.

The first device transmits a first certificate to the fourth device, where the first certificate may be used for authentication by the fourth device, and the first certificate may be an NOC of the first device in the first Fabric network.

The first device receives a second certificate transmitted by the fourth device, where the second certificate may be used for authentication by the first device, and the second certificate may be an NOC of the fourth device in the first Fabric network.

Optionally, the first certificate may be carried in a Sigma2 message. Optionally, the second certificate may be carried in a Sigma3 message.

Optionally, before the first device and the fourth device perform mutual authentication with each other, the fourth device may transmit a Sigma1 message to the first device, where the Sigma1 message is used to initiate a mutual authentication procedure corresponding to the target authentication mode.

In some embodiments, before the first device and the fourth device perform mutual authentication with each other, the first device may transmit eighth information to the fourth device. Optionally, the eighth information may be used to indicate the identifier of the first Fabric network and/or an identifier of the fourth device in the first Fabric network.

In some embodiments, the first device may interact with the fourth device by using a management frame in a communication network, so as to complete mutual authentication corresponding to the target authentication mode. For example, at least one of the Sigma1 message, the Sigma2 message, or the Sigma3 message is transmitted by using a Public Action frame.

Optionally, the eighth information may alternatively be carried in a management frame in a communication network, for example, carried in a Public Action frame.

Optionally, after the first device and the fourth device perform mutual authentication with each other, the first device may generate a first key based on the first certificate and the second certificate. Optionally, the fourth device may also generate a second key based on the first certificate and the second certificate.

Optionally, the first device may access the first communication network based on the first key. For example, the first device may use the first key as a Wi-Fi password, to perform Wi-Fi authentication, and access the Wi-Fi network after the Wi-Fi authentication succeeds.

In some embodiments, the first device and the fourth device may first establish a network connection with each other, and then interact with each other via the network connection, so as to complete mutual authentication corresponding to the target authentication mode. Optionally, the network connection established between the first device and the fourth device may be unencrypted. For example, before the first device and the fourth device perform mutual authentication with each other, the first device and the fourth device may establish a first communication network connection with each other. The first communication network connection may be a connection corresponding to the first communication network.

Optionally, when establishing the first communication network connection, the first device may transmit a Wi-Fi Association Request frame to the fourth device. Optionally, the fourth device may transmit a Wi-Fi Association Response frame to the first device. Optionally, the eighth information may be carried in a Wi-Fi Association Request frame.

Optionally, at least one of the Sigma1 message, the Sigma2 message, or the Sigma3 message may be transmitted via the first communication network connection.

Further, the first device and the fourth device may negotiate a third key. Optionally, the third key may be used to encrypt data between the first device and the fourth device. For example, the first communication network may be a Wi-Fi network. When the first device and the fourth device interact with each other by using the Wi-Fi network, the third key may encrypt data transmitted between the first device and the fourth device.

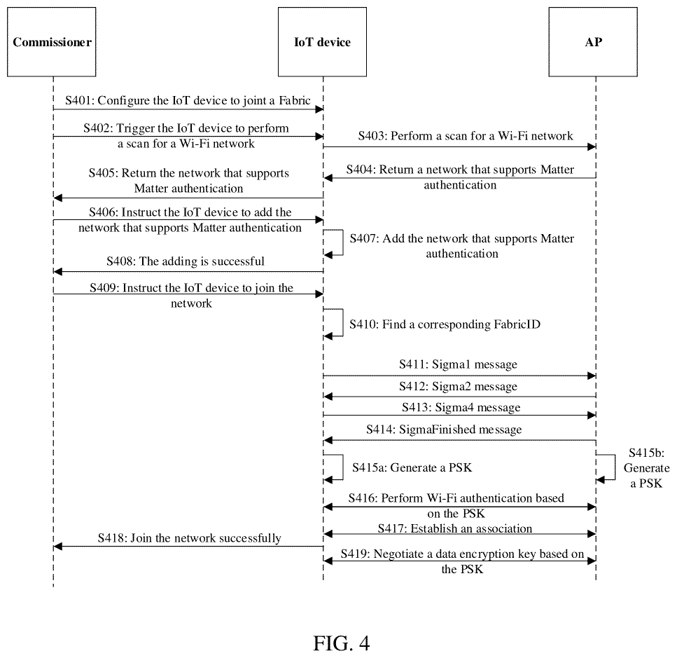

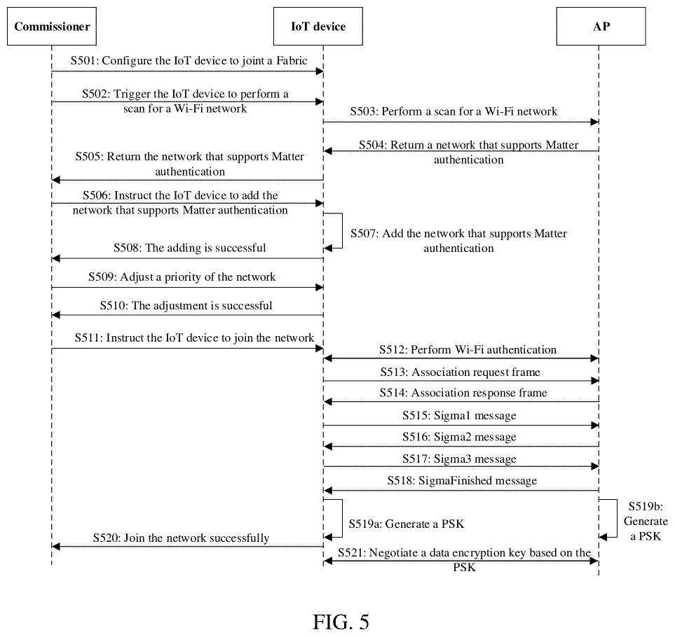

With reference to FIG. 4 and FIG. 5, the foregoing solutions in FIG. 2 and FIG. 3 are described by using an example in which the first communication network is a Wi-Fi network, and the target authentication mode refers to performing authentication by using a Matter NOC as a credential.

FIG. 4 is a schematic flowchart of a method for accessing a network according to an embodiment of this application. A commissioner in FIG. 4 may be a mobile phone of a user or an APP in a mobile phone of a user, and an AP device supports accessing a Wi-Fi network of a target SSID by using a Matter NOC as a credential. The method 400 shown in FIG. 4 may include steps S401 to S419. Details are as follows.

In S401, the commissioner configures an IoT device to joint a Fabric, and issues an NOC. The Fabric supports the Matter protocol, and may also be referred to as a Matter Fabric.

In S402, the commissioner triggers the IoT device to perform a scan for a Wi-Fi network.

The commissioner triggers, by using a ScanNetworks command, the IoT device to perform a scan for a Wi-Fi network that supports Matter authentication. The Wi-Fi network that supports Matter authentication may be a Wi-Fi network that supports access by using a Matter NOC as a credential.

Parameters of the ScanNetworks command may be as follows:

| | | | | Qual- | | Confor- |
|---|---|---|---|---|---|---|
| ID | Name | Type | Constraint | ity | Default | mance |
| 0 | SSID | [octstr-def] | 1 to 32 | X | null | [WI] |
| 1 | Breadcrumb | uint64 | all | | | O |
| 2 | MatterType | bool | | | False | O |

MatterType is a newly added parameter, and MatterType may be the third information in the foregoing method 200. If MatterType is set to True, it indicates performing a scan for a Wi-Fi network that supports Matter authentication. If MatterType is set to False, it indicates not performing a scan for a Wi-Fi network that supports Matter authentication.

In S403, the IoT device performs a scan for a Wi-Fi network, and adds an IE indicating Matter authentication to a Probe Request frame. The IE indicating Matter authentication may be the first indication information in the foregoing method 200.

In S404, the AP returns a network that supports Matter authentication.

The AP returns, by using a Probe Response frame, an SSID (that is, a scan result) of a Wi-Fi network that supports Matter authentication, where an ID of a Matter Fabric where the AP is located is carried in an IE of the Probe Response frame. If the AP is configured to a plurality of Matter Fabrics, a FabricID list is returned. The IE of the Probe Response frame may be the first information in the foregoing method 200.

In S405, the IoT device returns the network that supports Matter authentication.

The IoT device returns, to the commissioner by using a ScanNetworksResponse command, the network that supports Matter authentication. A WiFiInterfaceScanResult structure in the WiFiScanResults list may be represented as follows:

| | | | | | | |
|---|---|---|---|---|---|---|
| | | | | Qual- | | Confor- |
| ID | Name | Type | Constraint | ity | Access | mance |

| | | | | |
|---|---|---|---|---|
| 0 | Security | WiFiSecurity | all | WI |
| 1 | SSID | [octstr-def] | max 32 | WI |
| 2 | BSSID | [octstr-def] | 6 | WI |
| 3 | Channel | uint16 | all | WI |
| 4 | WiFiBand | WiFiBand | all | [WI] |
| 5 | RSSI | int8 | all | [WI] |
| 6 | MatterFabrics | list[fabric-id] | | [WI] |

MatterFabrics is a newly added parameter, and MatterFabrics may be the fourth information in the foregoing method 200. For the Wi-Fi network that supports Matter authentication and that is obtained by scanning, MatterFabrics is a FabricID list returned by the AP. Otherwise, MatterFabrics should be null (Null).

In S406, the commissioner instructs the IoT device to add the network that supports Matter authentication.

The commissioner selects an SSID and a FabricID of a target network, and adds the network for the IoT device by using an AddOrUpdate WiFiNetwork command:

| | | | | | |
|---|---|---|---|---|---|
| ID | Name | Type | Constraint | Default | Conformance |

| | | | | |
|---|---|---|---|---|
| 0 | SSID | [octstr-def] | max 32 | M |
| 1 | Credentials | [octstr-def] | max 64 | M |
| 2 | Breadcrumb | uint64 | all | O |
| 3 | FabricID | fabric-id | | O |

FabricID is a newly added parameter, and FabricID may be the fifth information in the foregoing method 200. FabricID indicates an added Fabric identifier corresponding to a Wi-Fi network that supports Matter authentication. If a Wi-Fi network that does not support Matter authentication is added, FabricID is null.

If FabricID is True (has a value), it indicates that a Wi-Fi network that supports Matter authentication is added. In this case, the parameter Credentials may be null (even if the parameter is not null, the parameter should be processed as a meaningless character). If FabricID is False (has no value), it indicates that a network accessed is not a Wi-Fi network that supports Matter authentication.

In S407, the IoT device adds the network that supports Matter authentication.

After receiving the AddOrUpdate WiFiNetwork command, the IoT device should add the network that supports Matter authentication to the Networks attribute, that is, add a new NetworkInfo structure to the Networks attribute, to record the network that supports Matter authentication. The NetworkInfo structure may be as follows:

| | | | | | | |
|---|---|---|---|---|---|---|
| | | | | Qual- | | Confor- |
| ID | Name | Type | Constraint | ity | Access | mance |

| | | | | |
|---|---|---|---|---|
| 0 | NetworkID | [octstr-def] | 1 to 32 | M |
| 1 | Connected | bool | | M |
| 2 | FabricID | fabric-id | | O |

FabricID is a newly added parameter. A definition of FabricID is the same as that in S406.

In S408, the IoT device returns an indication of successful adding.

The IoT device returns a response to the commissioner by using a NetworkConfigResponse command, to indicate that the IoT device has successfully added the network.

In S409, the commissioner instructs the IoT device to join the network.

The commissioner instructs, by using a ConnectNetwork command, the IoT device to join the network. Parameters thereof may be as follows:

| ID | Name | Type | Constraint | Conformance |
|---|---|---|---|---|
| 0 | NetworkID | [octstr-def] | 1 to 32 | M |
| 1 | Breadcrumb | uint64 | all | O |

NetworkID may represent an identifier of the Wi-Fi network that supports Matter authentication.

In S410, the IoT device finds a FabricID corresponding to the Wi-Fi network that supports Matter authentication.

The IoT device finds the FabricID corresponding to the NetworkID from NetworkInfo.

In S411, the IoT device transmits a Sigma1 message to the AP.

The IoT device may transmit the Sigma1 message to the AP by using a Public Action frame. A parameter destinationId in the public action frame may be FabricID.

In S412, the AP transmits a Sigma2 message to the IoT device.

The AP may parse out the FabricID and find a corresponding AP certificate. Further, the AP may compose a Sigma2 message and transmit the Sigma2 message to the IoT device.

In S413, the IoT device transmits a Sigma3 message to the AP. The IoT device composes the Sigma3 message and transmits the Sigma3 message to the AP.

In S414, the AP transmits a SigmaFinished message to the IoT device. In this case, both parties complete certificate authenticated session establishment (CASE) mutual authentication.

In S415, the IoT device and the AP generate a PSK. The IoT device and the AP may generate the PSK by negotiating with each other.

In S416, the IoT device and the AP perform Wi-Fi authentication with each other based on the PSK, and use the PSK as a pairwise master key (PMK) of an authentication frame.

In S417, the IoT device and the AP perform Wi-Fi association with each other.

In S418, the IoT device notifies the commissioner that the IoT device successfully accesses the network.

The IoT device transmits a ConnectNetworkResponse command to the commissioner to notify the commissioner that the IoT device successfully accesses the network.

In S419, the AP and the IoT device negotiate, based on the PSK, a data encryption key (such as a group temporal key (GTK) and a pairwise transient key (PTK)) used for a Wi-Fi channel.

If the IoT device is disconnected from the network, the network connection may be restored by using the following method.

The IoT device may perform a re-scan for a Wi-Fi network and add an IE indicating support for Matter authentication to a Probe Request frame. The AP may return, by using a Probe Response frame, an SSID of a network that supports Matter authentication, where an ID of a Matter Fabric where the AP is located (a FabricID list, if the AP is configured to a plurality of Matter Fabrics) is carried in an IE of the Probe Response frame. The IoT device determines, based on the SSID, whether the network is a previous network to which the IoT device is connected; and if yes, the IoT device finds the corresponding FabricID (otherwise, the IoT device performs network access again according to the method described in S401 to S419). The IoT device repeats the steps described in S411 to S419, where a Sigma1 message is transmitted to the AP by using a Public Action frame, and the parameter destinationId is set to FabricID. After completing these steps, the IoT device is reconnected to the network.

FIG. 5 is a schematic flowchart of a method for accessing a network according to an embodiment of this application. The method 500 shown in FIG. 5 may include steps S501 to S521. Details are as follows.

In S501, the commissioner configures an IoT device to joint a Fabric, and issues an NOC. The Fabric supports the Matter protocol, and may also be referred to as a Matter Fabric.

In S502, the commissioner triggers the IoT device to perform a scan for a Wi-Fi network.

The commissioner triggers, by using a ScanNetworks command, the IoT device to perform a scan for a Wi-Fi network that supports Matter authentication. Parameters of the ScanNetworks command may be as follows:

| | | | | Qual- | | Confor- |
|---|---|---|---|---|---|---|
| ID | Name | Type | Constraint | ity | Default | mance |
| 0 | SSID | [octstr-def] | 1 to 32 | X | null | [WI] |
| 1 | Breadcrumb | uint64 | all | | | O |
| 2 | MatterType | bool | | | False | O |

MatterType is a newly added parameter, and MatterType may be the third information in the foregoing method 200. If MatterType is set to True, it indicates performing a scan for a Wi-Fi network that supports Matter authentication. If MatterType is set to False, it indicates not performing a scan for a Wi-Fi network that supports Matter authentication.

In S503, the IoT device performs a scan for a Wi-Fi network, and adds an IE indicating Matter authentication to a Probe Request frame. The IE indicating Matter authentication may be the first indication information in the foregoing method 200.

In S504, the AP returns a network that supports Matter authentication.

The AP returns, by using a probe response frame, an SSID (that is, a scan result) of a Wi-Fi network that supports Matter authentication, where an ID of a Matter Fabric where the AP is located is carried in an IE of the probe response frame. If the AP is configured to a plurality of Matter Fabrics, a FabricID list is returned. The IE of the Probe Response frame may be the first information in the foregoing method 200.

In S505, the IoT device returns the network that supports Matter authentication.

The IoT device returns, to the commissioner by using a ScanNetworksResponse command, the network that supports Matter authentication. A WiFiInterfaceScanResult structure in the WiFiScanResults list may be represented as follows:

| | | | | | | |
|---|---|---|---|---|---|---|
| | | | | Qual- | | Confor- |
| ID | Name | Type | Constraint | ity | Access | mance |

| | | | | |
|---|---|---|---|---|
| 0 | Security | WiFiSecurity | all | WI |
| 1 | SSID | [octstr-def] | max 32 | WI |
| 2 | BSSID | [octstr-def] | 6 | WI |
| 3 | Channel | uint16 | all | WI |
| 4 | WiFiBand | WiFiBand | all | [WI] |
| 5 | RSSI | int8 | all | [WI] |
| 6 | MatterFabrics | list[fabric-id] | | [WI] |

MatterFabrics is a newly added parameter, and MatterFabrics may be the fourth information in the foregoing method 200. For the Wi-Fi network that supports Matter authentication and that is obtained by scanning, MatterFabrics may be a FabricID list returned by the AP. Otherwise, MatterFabrics should be null (Null).

In S506, the commissioner instructs the IoT device to add the network that supports Matter authentication.

The commissioner selects an SSID of a target network, and adds the network for the IoT device by using an AddOrUpdate WiFiNetwork command:

| | | | | | |
|---|---|---|---|---|---|
| ID | Name | Type | Constraint | Default | Conformance |

| | | | | |
|---|---|---|---|---|
| 0 | SSID | [octstr-def] | max 32 | M |
| 1 | Credentials | [octstr-def] | max 64 | M |
| 2 | Breadcrumb | uint64 | all | O |
| 3 | MatterAuth | bool | | O |

MatterAuth is a newly added parameter, and MatterAuth may be the second indication information in the foregoing method 200. If MatterAuth is True, it indicates that a network accessed is a Wi-Fi network that supports Matter authentication. In this case, the parameter Credentials may be null (even if the parameter is not null, the parameter should be processed as a meaningless character). If MatterAuth is False, it indicates that a network accessed is not a Wi-Fi network that supports Matter authentication.

In S507, the IoT device adds the network that supports Matter authentication.

After receiving the AddOrUpdate WiFiNetwork command, the IoT device should add the network that supports Matter authentication to the Networks attribute, that is, add a new NetworkInfo structure to the Networks attribute, to record the network that supports Matter authentication. The NetworkInfo structure may be as follows:

| | | | | | | |
|---|---|---|---|---|---|---|
| | | | | Qual- | | Confor- |
| ID | Name | Type | Constraint | ity | Access | mance |

| | | | | |
|---|---|---|---|---|
| 0 | NetworkID | [octstr-def] | 1 to 32 | M |
| 1 | Connected | bool | | M |
| 2 | MatterFabrics | list[fabric-id] | | O |

MatterFabrics is a newly added parameter. A definition of MatterFabrics is the same as that in S505. Optionally, the MatterFabrics list herein may be an intersection set between Fabrics-D and Fabrics-A. Fabrics-D is a list of Fabrics where the IoT device is located. Fabrics-A is a FabricID list returned by the AP in S405).

In S508, the IoT device returns an indiction of successful adding.

The IoT device returns a response to the commissioner by using a NetworkConfigResponse command, to indicate that the IoT device has successfully added the network.

In S509, the commissioner adjusts a priority of the network.

The commissioner instructs, by using a ReorderNetwork command, the IoT device to set the priority of the network to the highest. The ReorderNetwork command may include the seventh information in the foregoing method 200.

In S510, the IoT device returns an indication of successful adjustment.

The IoT device returns a response to the commissioner by using a NetworkConfigResponse command, to indicate that the IoT device has successfully adjusted the priority of the network.

In S511, the commissioner instructs the IoT device to join the network.

The commissioner instructs, by using a ConnectNetwork command, the IoT device to join the network. Parameters thereof are as follows:

| ID | Name | Type | Constraint | Conformance |
|---|---|---|---|---|
| 0 | NetworkID | [octstr-def] | 1 to 32 | M |
| 1 | Breadcrumb | uint64 | all | O |
| 2 | FabricID | fabric-id | | O |

FabricID is an available FabricID selected by the commissioner from the MatterFabrics list of the NetworkInfo structure.

In S512, the IoT device and the AP perform Wi-Fi authentication with each other.

In S513, the IoT device transmits an association request frame to the AP.

The IoT device places the FabricID in the Wi-Fi association request frame, and transmits the Wi-Fi association request frame to the AP. The FabricID may be the ninth information in the foregoing method 200.

In S514, the AP transmits an association response frame to the IoT device.

The AP extracts the FabricID from the association request frame, finds a node identifier (NodeID) of the AP that corresponds to the FabricID (that is, a node identifier of the AP in the Fabric), and transmits the node identifier to the IoT device by using the Wi-Fi association response frame. The NodeID may be the tenth information in the foregoing method 200.

In S515, the IoT device transmits a Sigma1 message to the AP.

The IoT device may transmit the Sigma1 message to the AP based on an IP connection. In this case, the parameter destinationId may be the NodeID of the AP.

In S516, the AP transmits a Sigma2 message to the IoT device.

The AP may parse out the FabricID and find a corresponding AP certificate. Further, the AP may compose a Sigma2 message and transmit the Sigma2 message to the IoT device.

In S517, the IoT device transmits a Sigma3 message to the AP. The IoT device composes the Sigma3 message and transmits the Sigma3 message to the AP.

In S518, the AP transmits a SigmaFinished message to the IoT device. In this case, both parties complete CASE mutual authentication.

In S519, the IoT device and the AP generate a PSK. The IoT device and the AP may generate the PSK by negotiating with each other.

In S520, the IoT device notifies the commissioner that the IoT device successfully accesses the network.

The IoT device transmits a ConnectNetworkResponse command to the commissioner to notify the commissioner that the IoT device successfully accesses the network.

In S521, the AP and the IoT device negotiate, based on the PSK, a data encryption key (such as a GTK and a PTK) used for a Wi-Fi channel.

If the IoT device is disconnected from the network, the network connection may be restored by using the following method.

The IoT device may perform a re-scan for a Wi-Fi network and add an IE indicating support for Matter authentication to a Probe Request frame. The AP may return, by using a Probe Response frame, an SSID of a network that supports Matter authentication, where an ID of a Matter Fabric where the AP is located (a FabricID list, if the AP is configured to a plurality of Matter Fabrics) is carried in an IE of the Probe Response frame. The IoT device determines, based on the SSID, whether the network is a previous network to which the IoT device is connected; and if yes, the IoT device finds the corresponding FabricID (otherwise, the IoT device performs network access again according to the method described in S501 to S521). The IoT device repeats steps S513 to S521, where the FabricID is placed in the Wi-Fi association request frame, and the Wi-Fi association request frame is transmitted to the AP. After completing these steps, the IoT device is reconnected to the network.

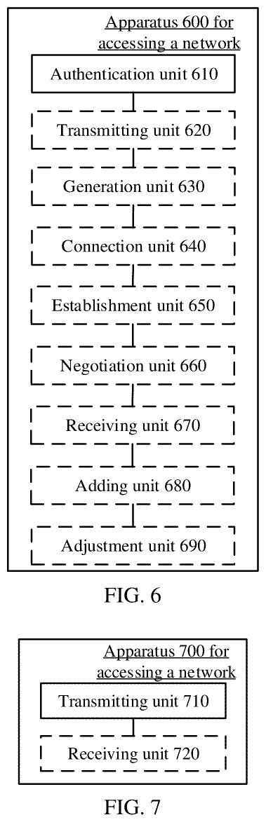

The method embodiments of this application are described above in detail with reference to FIG. 1 to FIG. 5. Apparatus embodiments of this application are described below in detail with reference to FIG. 6 to FIG. 10. It should be understood that the description of the method embodiment corresponds to the description of the apparatus embodiment. Therefore, for a part that is not described in detail, reference may be made to the foregoing method embodiment.

FIG. 6 is a schematic structural diagram of an apparatus for accessing a network according to an embodiment of this application. As shown in FIG. 6, the apparatus 600 includes an authentication unit 610. Details are as follows.

The authentication unit is configured to perform mutual authentication corresponding to a target authentication mode with a fourth device, to access a communication network that supports the target authentication mode.

Optionally, the authentication unit 610 is specifically configured to: receive a second certificate transmitted by the fourth device, where the second certificate is used for authentication by the apparatus, and the second certificate is a node operational certificate NOC of the fourth device in the first Fabric network; and transmit a first certificate to the fourth device, where the first certificate is used for authentication by the fourth device, and the first certificate is an NOC of the apparatus in the first Fabric network.

Optionally, the apparatus 600 further includes a transmitting unit 620, where before the performing mutual authentication corresponding to the target authentication mode with the fourth device, the transmitting unit 620 is configured to transmit eighth information to the fourth device, where the eighth information is used to indicate an identifier of the first Fabric network and/or an identifier of the fourth device in the first Fabric network.

Optionally, the eighth information is carried in a Sigma1 message, and/or the second certificate is carried in a Sigma2 message, and/or the first certificate is carried in a Sigma3 message.

Optionally, at least one of the Sigma1 message, the Sigma2 message, or the Sigma3 message is transmitted by using a Public Action frame.

Optionally, the authentication unit 610 is specifically configured to: transmit a first certificate to the fourth device, where the first certificate is used for authentication by the fourth device, and the first certificate is an NOC of the apparatus in the first Fabric network; and receive a second certificate transmitted by the fourth device, where the second certificate is used for authentication by the apparatus, and the second certificate is a node operational certificate NOC of the fourth device in the first Fabric network.

Optionally, the apparatus 600 further includes a transmitting unit 620, where before the performing mutual authentication corresponding to the target authentication mode with the fourth device, the transmitting unit 620 is configured to transmit eighth information to the fourth device, where the eighth information is used to indicate an identifier of the first Fabric network and/or an identifier of the fourth device in the first Fabric network.

Optionally, the first certificate is carried in a Sigma2 message, and/or the second certificate is carried in a Sigma3 message.

Optionally, at least one of the eighth information, the Sigma2 message, or the Sigma3 message is transmitted by using a Public Action frame.

Optionally, the apparatus 600 further includes a generation unit 630, where after the performing mutual authentication corresponding to the target authentication mode with the fourth device, the generation unit 630 is configured to generate a first key based on the first certificate and the second certificate.

Optionally, the first key is a shared key PSK.

Optionally, the apparatus 600 further includes a connection unit 640, configured to access the first communication network based on the first key.

Optionally, the apparatus 600 further includes an establishment unit 650, where before the performing mutual authentication corresponding to the target authentication mode with the fourth device, the establishment unit 650 is configured to establish the first communication network connection with the fourth device.

Optionally, the establishment unit 650 is specifically configured to: transmit ninth information to the fourth device, where the ninth information is used to indicate an identifier of the first Fabric network; and/or receive tenth information transmitted by the fourth device, where the tenth information is used to indicate an identifier of the fourth device in the first Fabric network.

Optionally, the ninth information is carried in a Wi-Fi Association Request frame, and/or the tenth information is carried in a Wi-Fi Association Response frame.

Optionally, the eighth information is carried in a Wi-Fi Association Request frame.

Optionally, at least one of the Sigma1 message, the Sigma2 message, or the Sigma3 message is transmitted via the first communication network connection.

Optionally, the apparatus 600 further includes a negotiation unit 660, where after the performing mutual authentication corresponding to the target authentication mode with the fourth device, the negotiation unit 660 is configured to negotiate a third key with the fourth device, where the third key is used to encrypt data between the apparatus and the fourth device.

Optionally, the apparatus 600 further includes a receiving unit 670, where before the performing mutual authentication corresponding to the target authentication mode with the fourth device, the receiving unit 670 is configured to receive first information transmitted by the second device, where the first information is used to indicate that a communication network where the second device is located supports a target authentication mode.

Optionally, the first information includes an identifier of the communication network and/or an identifier of a Fabric network where the second device is located.

Optionally, the apparatus 600 further includes a transmitting unit 620, where before the receiving the first information transmitted by the second device, the transmitting unit 620 is configured to transmit second information to the second device, where the second information is used to find a communication network that supports the target authentication mode.

Optionally, the second information includes first indication information used to indicate the target authentication mode.

Optionally, the first indication information is a MatterType field.

Optionally, the second information is carried in a Probe Request frame.

Optionally, the apparatus 600 further includes a receiving unit 670, where before the transmitting the second information to the second device, the receiving unit 670 is configured to receive third information transmitted by a third device, where the third information is used to trigger the apparatus to transmit the second information.

Optionally, the third information includes a MatterType field.

Optionally, the third information is carried in a ScanNetworks command.

Optionally, the apparatus 600 further includes a transmitting unit 620, where after the receiving the first information transmitted by the second device, the transmitting unit 620 is configured to transmit fourth information to a third device, where the fourth information is used to indicate a communication network that supports the target authentication mode.

Optionally, the fourth information includes an identifier of at least one communication network and/or an identifier of a Fabric network where a second device is located.

Optionally, the fourth information is carried in a ScanNetworksResponse command.

Optionally, the apparatus 600 further includes a receiving unit 670, where after the receiving the first information transmitted by the second device, the receiving unit 670 is configured to receive fifth information transmitted by the third device, where the fifth information is used to indicate a first communication network that supports the target authentication mode.

Optionally, the fifth information is carried in an AddOrUpdate WiFiNetwork command.

Optionally, the fifth information includes an identifier of the first communication network and an identifier of a first Fabric network.

Optionally, the apparatus 600 further includes an adding unit 680, where after the receiving the fifth information transmitted by the third device, the adding unit 680 is configured to add the first Fabric network to a Networks attribute.

Optionally, the identifier of the first Fabric network is stored in a FabricID field of the Networks attribute.

Optionally, the fifth information includes an identifier of the first communication network and/or second indication information, and the second indication information is used to indicate that the first communication network supports use of the target authentication mode.

Optionally, the apparatus 600 further includes an adding unit 680, where after the receiving the fifth information transmitted by the third device, the adding unit 680 is configured to add a Fabric network list to a Networks attribute.

Optionally, the Fabric network list includes a Fabric network where the second device is located, or an intersection set between Fabric networks where the apparatus is located and Fabric networks where the second device is located.

Optionally, the Fabric network list is stored in a MatterFabrics field of the Networks attribute.

Optionally, the apparatus 600 further includes a receiving unit 670, where after the receiving the fifth information transmitted by the third device, the receiving unit 670 is configured to receive sixth information transmitted by the third device, where the sixth information is used to indicate a first Fabric network.

Optionally, the sixth information includes an identifier of the first Fabric network.

Optionally, the sixth information is carried in a ConnectNetwork command.

Optionally, the apparatus 600 further includes a receiving unit 670, configured to receive seventh information transmitted by the third device, where the seventh information is used to instruct the apparatus to adjust a priority of the first communication network.

Optionally, the seventh information is carried in a ReorderNetwork command.

Optionally, the apparatus 600 further includes an adjustment unit 690, where after the receiving the seventh information transmitted by the third device, the adjustment unit 690 is configured to adjust the priority of the first communication network based on the seventh information.

Optionally, the first information is carried in a Probe Response frame.

Optionally, the target authentication mode refers to performing authentication by using a node operational certificate NOC in a Fabric network.

FIG. 7 is a schematic structural diagram of an apparatus for accessing a network according to an embodiment of this application. The apparatus 700 for accessing a network in FIG. 7 includes a transmitting unit 710. Details are as follows.

The transmitting unit 710 is configured to transmit first information to a first device, where the first information is used to indicate that a communication network where the apparatus is located supports a target authentication mode.

Optionally, the first information includes an identifier of the communication network and/or an identifier of a Fabric network where the apparatus is located.

Optionally, the apparatus 700 further includes a receiving unit 720, where before the transmitting the first information to the first device, the receiving unit 720 is configured to receive second information transmitted by the first device, where the second information is used to find a communication network that supports the target authentication mode.

Optionally, the second information includes first indication information used to indicate the target authentication mode.

Optionally, the first indication information is a MatterType field.

Optionally, the second information is carried in a Probe Request frame.

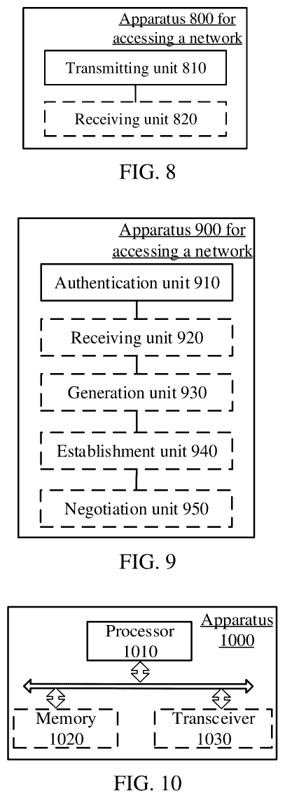

FIG. 8 is a schematic structural diagram of an apparatus for accessing a network according to an embodiment of this application. The apparatus 700 for accessing a network in FIG. 8 includes a transmitting unit 810. Details are as follows.

The transmitting unit 810 is configured to transmit third information to a first device, where the third information is used to trigger the first device to transmit second information, and the second information is used to find a communication network that supports the target authentication mode.

Optionally, the third information includes a MatterType field.

Optionally, the third information is carried in a ScanNetworks command.

Optionally, the apparatus 800 further includes a receiving unit 820, where after the transmitting the third information to the first device, the receiving unit 820 is configured to receive fourth information transmitted by the first device, where the fourth information is used to indicate a communication network that supports access using the target authentication mode.

Optionally, the fourth information includes an identifier of at least one communication network and/or an identifier of a Fabric network where a second device is located.

Optionally, the fourth information is carried in a ScanNetworksResponse command.

Optionally, after the transmitting the third information to the first device, the transmitting unit 810 is further configured to transmit fifth information to the first device, where the fifth information is used to indicate a first communication network that supports the target authentication mode.

Optionally, the fifth information is carried in an AddOrUpdate WiFiNetwork command.

Optionally, the fifth information includes an identifier of the first communication network and an identifier of a first Fabric network.

Optionally, the fifth information includes an identifier of the first communication network and/or second indication information, and the second indication information is used to indicate that the first communication network supports use of the target authentication mode.

Optionally, after the transmitting the fifth information to the first device, the transmitting unit 810 is further configured to transmit sixth information to the first device, where the sixth information is used to indicate a first Fabric network.

Optionally, the sixth information includes an identifier of the first Fabric network.

Optionally, the sixth information is carried in a ConnectNetwork command.

Optionally, the transmitting unit 810 is further configured to transmit seventh information to the first device, where the seventh information is used to instruct the first device to adjust a priority of the first communication network.

Optionally, the seventh information is carried in a ReorderNetwork command.

Optionally, the target authentication mode refers to performing authentication by using a node operational certificate NOC in a Fabric network.

FIG. 9 is a schematic structural diagram of an apparatus for accessing a network according to an embodiment of this application. The apparatus 900 for accessing a network in FIG. 9 includes an authentication unit 910. Details are as follows.

The authentication unit 910 is configured to perform mutual authentication corresponding to a target authentication mode with a first device, to cause the first device to access a communication network that supports the target authentication mode.

Optionally, the authentication unit 910 is specifically configured to: transmit a second certificate to the first device, where the second certificate is used for authentication by the first device, and the second certificate is a node operational certificate NOC of the apparatus in the first Fabric network; and receive a first certificate transmitted by the first device, where the first certificate is used for authentication by the apparatus, and the first certificate is an NOC of the first device in the first Fabric network.

Optionally, the apparatus 900 further includes a receiving unit 920, where before the performing mutual authentication corresponding to the target authentication mode with the first device, the receiving unit 920 is configured to receive eighth information transmitted by the first device, where the eighth information is used to indicate an identifier of the first Fabric network and/or an identifier of the apparatus in the first Fabric network.

Optionally, the eighth information is carried in a Sigma1 message, and/or the second certificate is carried in a Sigma2 message, and/or the first certificate is carried in a Sigma3 message.

Optionally, at least one of the Sigma1 message, the Sigma2 message, or the Sigma3 message is transmitted by using a Public Action frame.

Optionally, the authentication unit 910 is specifically configured to: receive a first certificate transmitted by the first device, where the first certificate is used for authentication by the apparatus, and the first certificate is an NOC of the first device in the first Fabric network; and transmit a second certificate to the first device, where the second certificate is used for authentication by the first device, and the second certificate is a node operational certificate NOC of the apparatus in the first Fabric network.

Optionally, the apparatus 900 further includes a receiving unit 920, where before the performing mutual authentication corresponding to the target authentication mode with the first device, the receiving unit 920 is configured to receive eighth information transmitted by the first device, where the eighth information is used to indicate an identifier of the first Fabric network and/or an identifier of the apparatus in the first Fabric network.

Optionally, the first certificate is carried in a Sigma2 message, and/or the second certificate is carried in a Sigma3 message.

Optionally, at least one of the eighth information, the Sigma2 message, or the Sigma3 message is transmitted by using a Public Action frame.

Optionally, the apparatus 900 further includes a generation unit 930, where after the performing mutual authentication corresponding to the target authentication mode with the first device, the generation unit 930 is configured to generate a second key based on the first certificate and the second certificate.

Optionally, the second key is a shared key PSK.

Optionally, the apparatus 900 further includes an establishment unit 940, where before the performing mutual authentication corresponding to the target authentication mode with the first device, the establishment unit 940 is configured to establish the first communication network connection with the first device.

Optionally, the establishment unit 940 is specifically configured to: receive ninth information transmitted by the first device, where the ninth information is used to indicate an identifier of the first Fabric network; and/or transmit tenth information to the first device, where the tenth information is used to indicate an identifier of the apparatus in the first Fabric network.

Optionally, the ninth information is carried in a Wi-Fi Association Request frame, and/or the tenth information is carried in a Wi-Fi Association Response frame.

Optionally, the eighth information is carried in a Wi-Fi Association Request frame.

Optionally, at least one of the Sigma1 message, the Sigma2 message, or the Sigma3 message is transmitted via the first communication network connection.

Optionally, the apparatus 900 further includes a negotiation unit 950, where after the performing mutual authentication corresponding to the target authentication mode with the first device, the negotiation unit 950 is configured to negotiate a third key with the first device, where the third key is used to encrypt data between the first device and the apparatus.

Optionally, the target authentication mode refers to performing authentication by using a node operational certificate NOC in a Fabric network.

FIG. 10 is a schematic structural diagram of an apparatus according to an embodiment of this application. Dashed lines in FIG. 9 indicate that a unit or module is optional. The apparatus 1000 may be configured to implement the method described in the foregoing method embodiments. The apparatus 1000 may be a chip or an apparatus for accessing a network.

The apparatus 1000 may include one or more processors 1010. The processor 1010 may support the apparatus 1000 in implementing the methods described in the foregoing method embodiments. The processor 1010 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 1000 may further include one or more memories 1020. The memory 1020 stores a program that may be executed by the processor 1010 to cause the processor 1010 to perform the methods described in the foregoing method embodiments. The memory 1020 may be separate from or integrated into the processor 1010.

The apparatus 1000 may further include a transceiver 1030. The processor 1010 may communicate with another device or chip through the transceiver 1030. For example, the processor 1010 may transmit data to and receive data from another device or chip through the transceiver 1030.

An embodiment of this application further provides a computer-readable storage medium for storing a program. The computer-readable storage medium may be applied to the apparatus for accessing a network provided in embodiments of this application, and the program causes a computer to perform the method executed by the apparatus for accessing a network in various embodiments of this application.

An embodiment of this application further provides a computer program product. The computer program product includes a program. The computer program product may be applied to the apparatus for accessing a network provided in embodiments of this application, and the program causes a computer to perform the method executed by the apparatus for accessing a network in various embodiments of this application.

An embodiment of this application further provides a computer program. The computer program may be applied to the apparatus for accessing a network provided in embodiments of this application, and the computer program causes a computer to perform the method executed by the apparatus for accessing a network in various embodiments of this application.

It should be understood that, in embodiments of this application, “B that is corresponding to A” means that B is associated with A, and B may be determined based on A. However, it should be further understood that, determining B based on A does not mean determining B based only on A, but instead, B may be determined based on A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that, in embodiments of this application, sequence numbers of the foregoing processes do not mean execution sequences. The execution sequences of the processes should be determined based on functions and internal logic of the processes, and should not be construed as any limitation on the implementation processes of the embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method for accessing a network, comprising:
performing, by a first device with a fourth device, mutual authentication corresponding to a target authentication mode, to access a communication network that supports the target authentication mode.

2. The method according to claim 1, wherein the performing, by the first device with the fourth device, mutual authentication corresponding to the target authentication mode comprises:
receiving, by the first device, a second certificate transmitted by the fourth device, wherein the second certificate is used for authentication by the first device, and the second certificate is a node operational certificate (NOC) of the fourth device in a first Fabric network; and
transmitting, by the first device, a first certificate to the fourth device, wherein the first certificate is used for authentication by the fourth device, and the first certificate is an NOC of the first device in the first Fabric network.

3. The method according to claim 2, wherein before the performing, by the first device with the fourth device, mutual authentication corresponding to the target authentication mode, the method further comprises:
transmitting, by the first device, eighth information to the fourth device, wherein the eighth information is used to indicate an identifier of the first Fabric network and/or an identifier of the fourth device in the first Fabric network.

4. The method according to claim 3, wherein the eighth information is carried in a Sigma1 message, and/or the second certificate is carried in a Sigma2 message, and/or the first certificate is carried in a Sigma3 message.

5. The method according to claim 4, wherein at least one of the Sigma1 message, the Sigma2 message, or the Sigma3 message is transmitted by using a Public Action frame.

6. The method according to claim 3, wherein the first certificate is carried in a Sigma2 message, and/or the second certificate is carried in a Sigma3 message.

7. The method according to claim 6, wherein at least one of the eighth information, the Sigma2 message, or the Sigma3 message is transmitted by using a Public Action frame.

8. The method according to claim 2, wherein after the performing, by the first device with the fourth device, mutual authentication corresponding to the target authentication mode, the method further comprises:
generating, by the first device, a first key based on the first certificate and the second certificate.

9. The method according to claim 8, wherein the first key is a pre-shared key (PSK).

10. The method according to claim 8, further comprising:
accessing, by the first device, a first communication network based on the first key.

11. A first device, comprising a processor configured to:
perform, with a fourth device, mutual authentication corresponding to a target authentication mode, to access a communication network that supports the target authentication mode.

12. A method for accessing a network, comprising:
performing, by a fourth device with a first device, mutual authentication corresponding to a target authentication mode, to cause the first device to access a communication network that supports a target authentication mode.

13. The method according to claim 12, wherein the performing, by the fourth device with the first device, mutual authentication corresponding to the target authentication mode comprises:
transmitting, by the fourth device, a second certificate to the first device, wherein the second certificate is used for authentication by the first device, and the second certificate is a node operational certificate (NOC) of the fourth device in a first Fabric network; and
receiving, by the fourth device, a first certificate transmitted by the first device, wherein the first certificate is used for authentication by the fourth device, and the first certificate is an NOC of the first device in the first Fabric network.

14. The method according to claim 13, wherein before the performing, by the fourth device with the first device, mutual authentication corresponding to the target authentication mode, the method further comprises:
receiving, by the fourth device, eighth information transmitted by the first device, wherein the eighth information is used to indicate an identifier of the first Fabric network and/or an identifier of the fourth device in the first Fabric network.

15. The method according to claim 14, wherein the eighth information is carried in a Sigma1 message, and/or the second certificate is carried in a Sigma2 message, and/or the first certificate is carried in a Sigma3 message.

16. The method according to claim 15, wherein at least one of the Sigma1 message, the Sigma2 message, or the Sigma3 message is transmitted by using a Public Action frame.

17. The method according to claim 16, wherein the first certificate is carried in a Sigma2 message, and/or the second certificate is carried in a Sigma3 message.

18. The method according to claim 17, wherein at least one of the eighth information, the Sigma2 message, or the Sigma3 message is transmitted by using a Public Action frame.

19. The method according to any one of claim 13, wherein after the performing, by the fourth device with the first device, mutual authentication corresponding to the target authentication mode, the method further comprises:
generating, by the fourth device, a second key based on the first certificate and the second certificate.

20. The method according to claim 19, wherein the second key is a pre-shared key (PSK).
